(19) United States
(12) Patent Application Publication
(10) Pub. No.: US 2010/0126227 A1
(43) Pub. Date: May 27, 2010

(54) ELECTROSTATICALLY DEPOSITING CONDUCTIVE FILMS DURING GLASS DRAW

(76) Inventors: Curtis Robert Fekety, Tioga, PA (US); Andrey V. Filippov, Painted Post, NY (US); Clinton Damon Osterhout, Beaver Dams, NY (US); Carlton Maurice Truesdale, Corning, NY (US)

Correspondence Address: CORNING INCORPORATED, SP-TI-3-1, CORNING, NY, 14831, US

(21) Appl. No.: 12/570,762

(22) Filed: Sep. 30, 2009

Related U.S. Application Data
(60) Provisional application No. 61/117,373, filed on Nov. 24, 2008.

(51) Int. Cl. C03B 37/022; C03C 17/00; C03C 17/06

(52) U.S. Cl. 65/441; 65/60.1; 65/60.4; 65/60.5

(57) ABSTRACT

Methods for coating a glass substrate as it is being drawn, for example, during fusion draw or during fiber draw are described. The coatings are conductive coatings which can also be transparent. The conductive thin film coated glass substrates can be used in, for example, display devices, solar cell applications and in many other rapidly growing industries and applications.

This application claims the benefit of priority to U.S. Provisional Application No. 61/117,373 filed on Nov. 24, 2008.

### BACKGROUND

1. Field of the Invention

Embodiments of the invention relate to methods for coating a substrate and more particularly to methods for coating a glass substrate with a conductive thin film during glass draw using, for example, electrostatic deposition.

2. Technical Background

Transparent and electrically conductive thin film coated glass is useful for a number of applications, for example, in display applications such as the back plane architecture of display devices, for example, liquid crystal displays (LCD), and organic light-emitting diodes (OLED) for cell phones. Transparent and electrically conductive thin film coated glass is also useful for solar cell applications, for example, as the transparent electrode for some types of solar cells and in many other rapidly growing industries and applications.

Conventional methods for coating glass substrates typically include vacuum pumping of materials, cleaning of glass surfaces prior to coating, heating of the glass substrate prior to coating and subsequent depositing of specific coating materials.

Typically, deposition of conductive transparent thin films on glass substrates is performed in a vacuum chamber either by sputtering or by chemical vapor deposition (CVD), for example, plasma enhanced chemical vapor deposition (PECVD).

Sputtering of conductive transparent thin films on glass, for example, sputter deposition of indium doped tin oxide on glasses, has one or more of the following disadvantages: large area sputtering is challenging, time consuming, and generally produces non-uniform films on glass substrates, especially glass substrates of increased size, for example, display glass for televisions.

The glass cleaning prior to coating in several conventional coating methods introduces complexity and additional cost. Also, several conventional coating methods require a doping of the coating which is typically difficult and introduces additional processing steps.

It would be advantageous to develop a method for coating a glass substrate with a conductive thin film while increasing coating density and/or minimizing morphology variations evident in conventional coating methods while reducing manufacturing cost and manufacturing time.

### SUMMARY

Methods for coating a glass substrate with a conductive thin film as described herein, addresses one or more of the above-mentioned disadvantages of the conventional coating methods, in particular, when the coating comprises a metal and/or a metal oxide.

In one embodiment, a method for coating a glass substrate during glass draw is disclosed. The method comprises drawing a glass substrate, applying an electric field proximate to the glass substrate being drawn, and passing a flow of aerosol comprising conductive particles through the electric field and onto the glass substrate being drawn.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that both the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification. The drawings illustrate one or more embodiment(s) of the invention and together with the description serve to explain the principles and operation of the invention.

### BRIEF DESCRIPTION OF THE DRAWINGS

The invention can be understood from the following detailed description either alone or together with the accompanying drawings.

FIG. 1A is a side view schematic of applying the aerosol to a glass substrate as it is being drawn according to one embodiment.

FIG. 1B is a front view schematic of applying the aerosol to a glass substrate as it is being drawn according to the embodiment shown in FIG. 1A.

FIG. 2 is a schematic of applying the aerosol to a glass substrate as it is being drawn according to one embodiment.

FIG. 3 side view schematic of applying the aerosol to a glass substrate as it is being drawn according to one embodiment.

### DETAILED DESCRIPTION

Reference will now be made in detail to various embodiments of the invention, an example of which is illustrated in the accompanying drawings.

In one embodiment, a method for coating a glass substrate during glass draw is disclosed. The method comprises drawing a glass substrate, applying an electric field proximate to the glass substrate being drawn, and passing a flow of aerosol comprising conductive particles through the electric field and onto the glass substrate being drawn.

The conductive particles, according to one embodiment, comprise a metal, a metal oxide, a metal halide, a dopant, or combinations thereof. Exemplary metal halides, are SnCl₄, SnCl₂, SnBr₄, ZnCl₂, and combinations thereof. Exemplary metal oxides are ZnO, SnO₂, In₂O₃, and combinations thereof. Exemplary metals are Sn, Zn, In, and combinations thereof. The conductive particles can be 500 nanometers in diameter, for example, 200 nanometers or less, for example, 10 nanometers to 100 nanometers.

The method according to one embodiment, further comprises generating the flow of conductive particles using spray pyrolysis, flame synthesis, a hot wall reactor, an induction particle generator, an atomizer, or combinations thereof.

Exemplary hot wall reactors, for example, induction particle generators, for example, those described in commonly owned U.S. Patent Application Publication 2008/0035682 and U.S. patent application Ser. No. 11/881,119 filed on Jul. 25, 2007, may be used to produce a flow of aerosol.

Exemplary flame spray pyrolysis reactors, for example, those described in commonly owned U.S. Pat. Nos. 5,979,185 and 6,260,385, may also be used to produce a flow of aerosol. The flow of aerosol, according to one embodiment, comprises carrier gases for the conductive particles, for example, nitrogen, oxygen and the like or combinations thereof and precursors, reactants, particles and the like or combinations thereof. The flow of aerosol can comprise aerosol droplets or can comprise dry conductive particles. The aerosol droplets, in one embodiment, have a droplet size of 4000 nanometers or less in diameter, for example, a droplet size of from 10 nanometers to 1000 nanometers, for example, 50 nanometers to 450 nanometers.

Conductive particles produced by gas-phase synthesis are typically charged positively or negatively during chemical reactions used to produce the conductive particles. In one embodiment, the method further comprises charging the conductive particles prior to passing the flow of aerosol comprising conductive particles through the electric field. Charging the conductive particles, according to one embodiment, comprises passing the generated flow of conductive particles through a charging zone comprising a charger to form charged conductive particles. The charger can be selected from a corona charger, a radioactive gas ionizer, a photoelectric charger, an induction charger and combinations thereof. Using a charger, the conductive particles can be additionally charged by acquiring charge from airborne ions produced by the charger.

The additional particle charging in the charging zone could be effectively accomplished by multiple charging mechanisms or a combination of several charging mechanisms. For example, the gas ions used for particle charging can be produced by a radioactive gas ionizer. The aerosol particles can be charged by irradiating aerosol by UV light or soft X-rays (photoelectric charging) produced by corresponding sources of electromagnetic radiation.

Exemplary systems for electrostatic deposition are described in commonly owned U.S. Pat. No. 7,361,207 and U.S. Pat. No. 7,393,385.

In one embodiment, the conductive particles on the glass substrate sinter to form a conductive film. The conductive film is transparent, in one embodiment. The conductive film can comprise a metal, a metal oxide, a dopant, or combinations thereof. In one embodiment, the conductive film comprises SnO₂, ZnO, In₂O₃, Zn, Sn, In, or combinations thereof. In one embodiment, the conductive film comprises Cl doped SnO₂, F and Cl doped SnO₂, F doped SnO₂, Sn doped In₂O₃, Al doped ZnO, Cd doped SnO₂, or combinations thereof.

The conductive thin film, in one embodiment, has a thickness of 2000 nanometers or less, for example, 10 nanometers to 1000 nanometers, for example, 10 nanometers to 500 nanometers.

The glass substrate can be selected from a glass fiber and a glass ribbon. Exemplary draw processes include draw-down glass forming (e.g. fusion draw, tube drawing, slot drawing and vertical draw. One embodiment of the invention comprises applying the aerosol to a glass ribbon being drawn from an isopipe in a fusion draw process.

During the glass draw process, the nascent glass surface of the glass substrate is typically pristine and ideal for depositing aerosol on the glass substrate and subsequently forming a conductive thin film, in part, due to the temperature of the glass substrate and due to the glass substrate being touched only by the equipment used during the glass draw process. Thus, cleaning the glass substrates prior to coating is not required.

According to one embodiment, applying the aerosol comprises applying the aerosol to the glass substrate that has reached or is below its glass transition temperature.

According to one embodiment, applying the aerosol comprises applying the aerosol to the glass substrate when the glass substrate is elastic.

According to one embodiment, the method comprises applying the aerosol to the glass substrate that is at a temperature of from 200 degrees Celsius to 800 degrees Celsius, for example, at a temperature of from 350 degrees Celsius to 600 degrees Celsius as the glass substrate is being drawn. In some applications, the upper end of the temperature range is dependent on the softening point of the glass substrate. The conductive films are typically applied at a temperature below the softening point of the glass substrate. According to one embodiment, the conductive film is formed at ambient pressure.

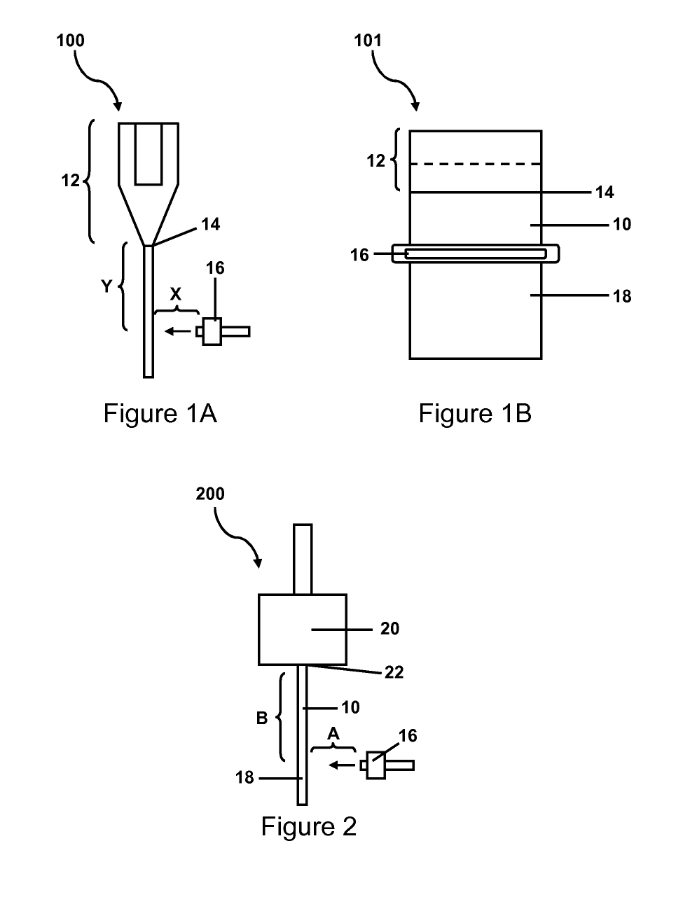

Features 100 and 101 of a method of coating a glass substrate during the fusion draw process are shown in FIG. 1A and FIG. 1B. The temperature of the glass substrate 10, in this embodiment, glass ribbon, as it exits the isopipe 12 can be 1100° C. or more. The distance Y from the outlet of the isopipe 14 to the apparatus carrying the aerosol 16 can be adjusted so as to correspond to the desired temperature of the glass ribbon. The desired temperature of the glass ribbon can be determined by the temperature required, for example, to form the metal oxide upon deposition of a metal halide on the glass ribbon to form a conductive thin film coated glass substrate 18, in this example, conductive thin film coated glass ribbon. Similarly, the distance X from the flow of aerosol to the glass ribbon can be adjusted so as to correspond with a desired velocity of the aerosol.

Feature 200 of a method of coating a glass substrate during the fiber draw process are shown in FIG. 2. The temperature of the glass substrate 10, in this embodiment, a glass fiber, as it exits the furnace 20 can be 1100° C. or more. The distance B from the outlet of the furnace 22 to the apparatus carrying the aerosol 16 can be adjusted so as to correspond to the desired temperature of the glass fiber. According to another embodiment, distance B can be the distance from a cooling unit (not shown) to the apparatus carrying the aerosol. The desired temperature of the glass fiber can be determined by, for example, the temperature required to form the metal oxide upon deposition of a metal halide on the glass fiber to form a conductive thin film coated glass substrate 18, in this example, conductive thin film coated glass fiber. Similarly, the distance A from the apparatus carrying the aerosol to the glass fiber can be adjusted so as to correspond with a desired velocity of the aerosol.

Distances, X and Y in FIG. 1A, or A and B in FIG. 2, can be adjusted so as to deposit aerosol droplets or dry conductive particles onto the glass substrate.

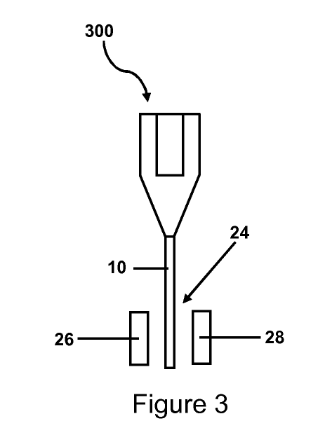

Applying the electric field, in one embodiment, comprises applying alternating current (AC) or direct current (DC) to one or more electrodes to produce the electric field that deposits the charged conductive particles onto the glass substrate as the glass substrate is being drawn. For example, as shown by features 300 of the invention in FIG. 3, two oppositely charged opposing electrodes 26 and 28 can be located on opposite sides of the glass being drawn. Glass substrate 10 is being drawn, an electric field is applied proximate to the glass substrate being drawn by the electrodes 26 and 28, and a flow of charged aerosol 24 comprising conductive particles is passed through the electric field and onto the glass substrate, thus coating the glass substrate.

High capture efficiency of the electrostatic deposition process can allow deposition of even the smallest particles such as SnO₂ particles onto the substrate. Elevated temperature of the substrate can facilitate the adherence of the conductive particles on the substrate and the conductive particles subsequent sintering to form a conductive film. The cleanness of the nascent glass surface can minimize additional process steps of cleaning of the glass before film deposition. Expensive vacuum systems and their complex operation are not needed for the film deposition. The deposition can be carried out in ambient conditions and doping/alloying of the film species is relatively easy.

Methods according to the invention have the versatility of deposition of single species conductive thin films, complex multiple species thin films, ‘in-situ’ dopant addition to the films, and/or gas flow turbulence minimization to ensure uniformity of the films. The deposition of low temperature evaporating metallic species (such as, Sn, Zn) instead of its high temperature oxides (such as, SnO₂, ZnO) and subsequent conversion of the metallic oxide by partial sintering and/or thermal treatment of the film is advantageous, since considerably lower temperatures (e.g. 300° C. for Sn, >1900° C. for SnO₂) can be used to make the conductive films. The drawing glass temperature is high enough for metal particle sintering process. Generally, the oxidation of metallic species can happen either in a pre-deposition, synthesis stage, or after the deposition, immediately before sintering.

It will be apparent to those skilled in the art that various modifications and variations can be made to the present invention without departing from the spirit or scope of the invention. Thus, it is intended that the present invention cover the modifications and variations of this invention provided they come within the scope of the appended claims and their equivalents.

What is claimed is:

1. A method for coating a glass substrate during glass draw, the method comprising:
drawing a glass substrate;
applying an electric field proximate to the glass substrate being drawn; and
passing a flow of aerosol comprising conductive particles through the electric field and onto the glass substrate being drawn.

2. The method according to claim 1, further comprising generating the flow of conductive particles using spray pyrolysis, flame synthesis, a hot wall reactor, an induction particle generator, an atomizer, or combinations thereof.

3. The method according to claim 1, wherein the conductive particles on the glass substrate sinter to form a conductive film.

4. The method according to claim 3, wherein the conductive film is transparent.

5. The method according to claim 3, wherein the conductive film comprises a metal, a metal oxide, a dopant, or combinations thereof.

6. The method according to claim 1, wherein the conductive particles comprise a metal, a metal oxide, a metal halide, a dopant, or combinations thereof.

7. The method according to claim 1, further comprising charging the conductive particles prior to passing the flow of aerosol comprising conductive particles through the electric field.

8. The method according to claim 7, wherein charging the conductive particles comprises passing the generated flow of conductive particles through a charging zone comprising a charger to form charged conductive particles.

9. The method according to claim 8, wherein the charger is selected from a corona charger, a radioactive gas ionizer, a photoelectric charger, an induction charger and combinations thereof.

10. The method according to claim 8, wherein applying the electric field comprises applying alternating current or direct current to one or more electrodes to produce the electric field that deposits the charged conductive particles onto the glass substrate as the glass substrate is being drawn.

11. The method according to claim 10, wherein two oppositely charged opposing electrodes are located on opposite sides of the glass being drawn.

12. The method according to claim 1, wherein the flow of aerosol comprises aerosol droplets.

13. The method according to claim 1, wherein the glass substrate is selected from a glass fiber and a glass ribbon.

14. The method according to claim 1, which comprises applying the conductive particles to the glass substrate that has reached or is below its glass transition temperature.

15. The method according to claim 1, which comprises applying the conductive particles to the glass substrate when the glass substrate is elastic.

16. The method according to claim 1, which comprises applying the conductive particles to the glass substrate that is at a temperature of from 200 degrees Celsius to 800 degrees Celsius.

17. The method according to claim 16, which comprises applying the conductive particles to the glass substrate that is at a temperature of from 350 degrees Celsius to 600 degrees Celsius.
